(19) United States
(12) Patent Application Publication
(10) Pub. No.: US 2014/0119798 A1
(43) Pub. Date: May 1, 2014

(54) IMAGE FORMING APPARATUS, IMAGE FORMING METHOD AND COMPUTER READABLE MEDIUM

(71) Applicant: FUJI XEROX CO., LTD., Tokyo (JP)

(72) Inventor: Hideki KIMURA, Yokohama-shi (JP)

(73) Assignee: FUJI XEROX CO., LTD., Tokyo (JP)

(21) Appl. No.: 13/902,082

(22) Filed: May 24, 2013

(30) Foreign Application Priority Data
Nov. 1, 2012 (JP) 2012-241999

(51) Int. Cl. G03G 15/20

(52) U.S. Cl. CPC G03G 15/20
USPC 399/341

(57) ABSTRACT

An image forming apparatus includes: a forming unit that forms an image on a medium; a fixing unit that fixes the formed image; and a control unit that performs control such that the forming unit forms a base image and the fixing unit fixes the base image, changes settings of the forming unit and the fixing unit after the fixing of base image, and performs control such that the forming unit forms an uneven pattern image so as to be superimposed on the base image and the fixing unit fixes the uneven pattern image.

### CROSS-REFERENCE TO RELATED APPLICATIONS

This application is based on and claims priority under 35 USC 119 from Japanese Patent Application No. 2012-241999 filed on Nov. 1, 2012.

### BACKGROUND

1. Technical Field

The present invention relates to an image forming apparatus and an image forming program.

2. Related Art

Concave and convex portions have been formed on the surface of a printed matter in order to make various printed matters, such as labels, packages, book covers, and pamphlets, have a good design, high quality, and good texture.

### SUMMARY

According to an aspect of the invention, there is provided an image forming apparatus including: a forming unit that forms an image on a medium; a fixing unit that fixes the formed image; and a control unit that performs control such that the forming unit forms a base image and the fixing unit fixes the base image, changes the settings of the forming unit and the fixing unit, and performs control such that the forming unit forms an uneven pattern image so as to be superimposed on the base image and the fixing unit fixes the uneven pattern image.

### BRIEF DESCRIPTION OF THE DRAWINGS

FIG. 1 is a configuration diagram illustrating an embodiment of the invention.

FIG. 2 is a flowchart illustrating an example of an operation according to the embodiment of the invention.

FIG. 3 is a diagram illustrating examples of a base image and an uneven pattern image and an example of a formed image.

FIGS. 4A and 4B are diagrams illustrating another example of the uneven pattern image.

FIG. 5 is a diagram illustrating still another example of each of the base image and the uneven pattern image.

FIGS. 6A and 6B are diagrams illustrating an example of the control of a forming unit and a fixing unit by a control unit.

FIG. 7 is a configuration diagram illustrating a modification of the embodiment of the invention.

FIG. 8 is a diagram illustrating examples of a computer program, a storage medium storing the computer program, and a computer when the functions described in the embodiment of an image forming apparatus according to the invention and the modification thereof are implemented by the computer program.

### DESCRIPTION OF REFERENCE NUMERALS AND SIGNS

11: FORMING UNIT

12: FIXING UNIT

13: CONTROL UNIT

14: RECEIVING UNIT

15: GENERATING UNIT

21: PROGRAM

22: COMPUTER

31: MAGNETO-OPTICAL DISC

32: OPTICAL DISC

33: MAGNETIC DISK

34: MEMORY

41: CPU

42: INTERNAL MEMORY

43: READING UNIT

44: HARD DISK

45: INTERFACE

46: COMMUNICATION UNIT

### DETAILED DESCRIPTION

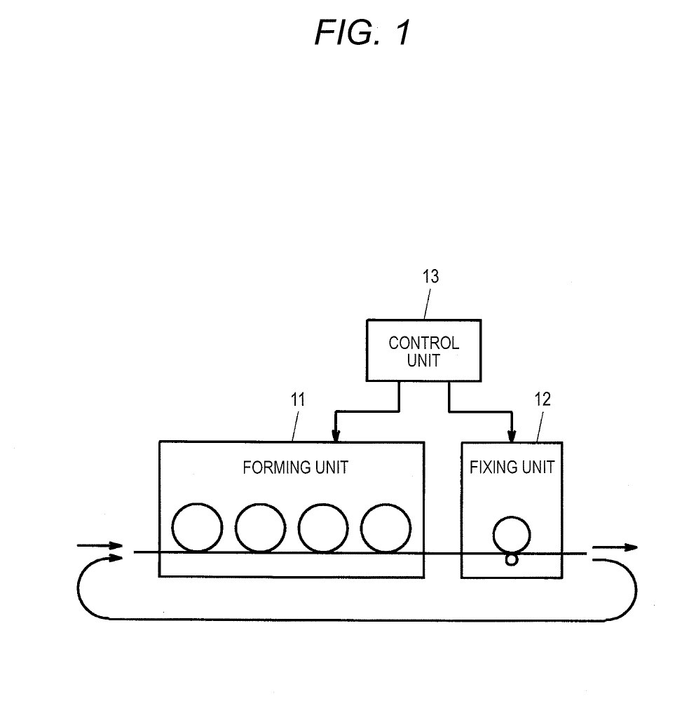

FIG. 1 is a configuration diagram illustrating an embodiment of the invention. In FIG. 1, reference numeral 11 indicates a forming unit, reference numeral 12 indicates a fixing unit, and reference numeral 13 indicates a control unit. In this embodiment, it is assumed that an image is formed by electrophotography.

The forming unit 11 forms a given color image on a medium. A general configuration for forming a color image may be used and a color material for forming a general color image may be used. In FIG. 1, four color materials are used. However, three or five or more color materials may be used. There are various methods of forming color images and any of them may be used. For example, any of various methods including a tandem method, a cycle method, a method using an intermediate transfer member, and a method without using an intermediate transfer member, may be used.

The fixing unit 12 fixes the image which is formed with the color materials on the medium by the forming unit 11 to the medium. For example, a method of fixing the color materials with heat may be used.

The control unit 13 controls each unit to control the formation of images on the medium. As a control process when an image with concave and convex portions is formed, first, the control unit 13 performs control such that the forming unit 11 forms a base image, the fixing unit 12 fixes the base image, the forming unit 11 forms an uneven pattern image so as to be superimposed on the base image, and the fixing unit 12 fixes the uneven pattern image. At that time, the settings of the forming unit 11 and the fixing unit 12 when the base image is formed and fixed are different from the settings of the forming unit 11 and the fixing unit 12 when the uneven pattern image is formed and fixed. Specifically, when the uneven pattern image is formed, control may be performed such that the amount of color material is more than that when the base image is formed so that unevenness (concavity and convexity) made by the color material appears. In addition, when the uneven pattern image is formed, control may be performed such that the uneven pattern image has a gloss, as compared to when the base image is formed. In addition, the processing conditions for the base image and the uneven pattern image may be controlled such that the unevenness (concavity and convexity) is not damaged by, for example, color adjustment or screen processing. When the base image and the uneven pattern image are formed in the same color or similar color, an image which has a gloss due to concave and convex portions is obtained.

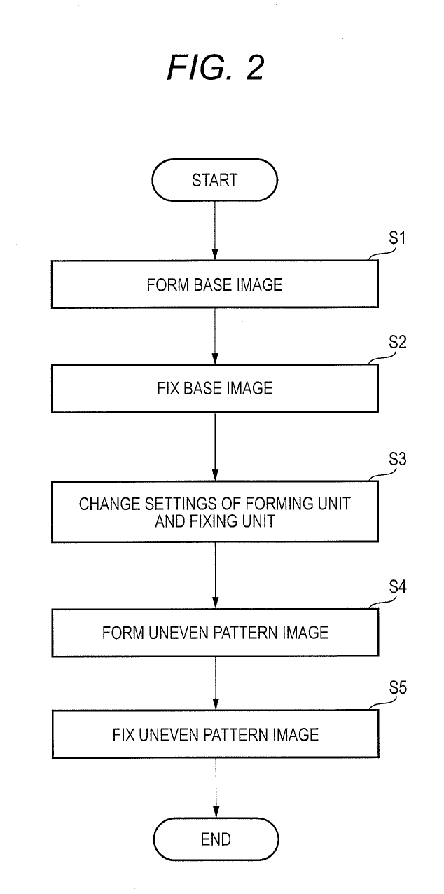

FIG. 2 is a flowchart illustrating an example of an operation according to the embodiment of the invention. First, in S1, the forming unit 11 forms the base image on a medium. In S2, the fixing unit 12 fixes the formed image to the medium. When the formation of the base image ends, the medium returns to the forming unit 11. In S3, the control unit 13 changes the settings of the forming unit 11 and the fixing unit 12. In S4, the forming unit 11 forms the uneven pattern image on the medium. In S5, the fixing unit 12 fixes the formed image to the medium. In this way, two image forming and fixing processes are performed.

The medium may be automatically returned to the forming unit 11 by a mechanism for returning the medium, or it may be manually returned by the operator.

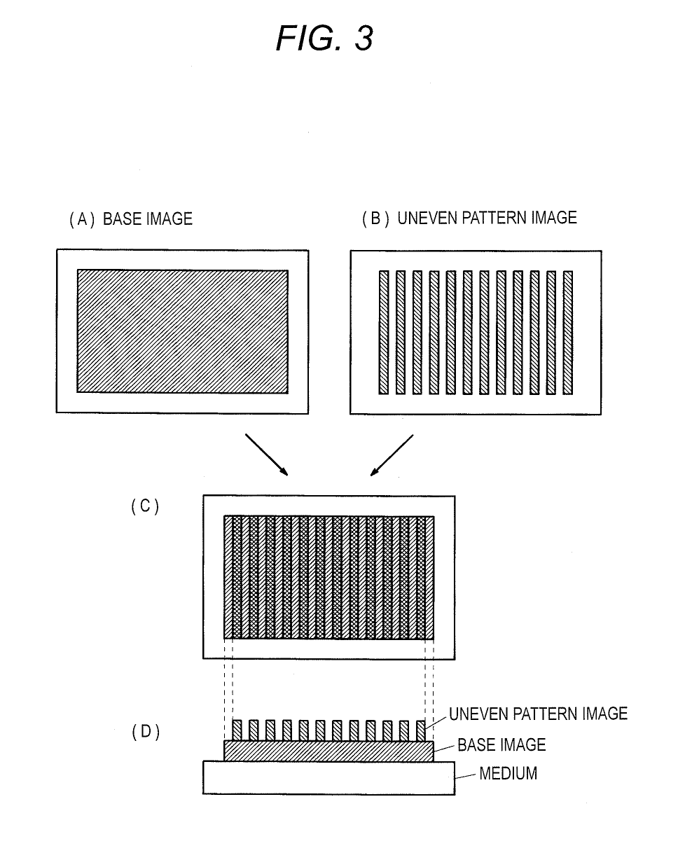

FIG. 3 is a diagram illustrating an example of the images formed as the base image and the uneven pattern image. In FIG. 3, for convenience of illustration, colored portions of the base image and the uneven pattern image are hatched. The base image and the uneven pattern image are represented by different oblique lines. However, the colored portions thereof have the same or similar color.

(A) of FIG. 3 shows an example of the base image. In (A) of FIG. 3, a region which is decorated by the concave and convex portions is painted in a single color. Of course, the base image may include, for example, letters or figures. However, in this embodiment, it is assumed that the region which is decorated by the concave and convex portions is painted in the same or similar color as that of the superimposed uneven pattern image.

(B) of FIG. 3 shows an example of the uneven pattern image. In (B) of FIG. 3, a hatched region is a convex portion and a non-hatched region is a concave portion. The color of the convex region is the same or similar to the color of the superimposed base image. In this example, the color of the region is a single color which is the same or similar to the color of the base image shown in (A) of FIG. 3.

After the base image shown (A) of in FIG. 3 is formed and fixed, the uneven pattern image shown in (B) of FIG. 3 is formed and fixed. In this way, the image shown in (C) of FIG. 3 is formed. As shown in (D) of FIG. 3 which is an exaggerated cross-sectional view illustrating the formed image, the base image is formed on the medium and the convex portion of the uneven pattern image is formed on the base image. When an image is formed, a thick portion is generated by a color material. The thick portion appears as a difference in height between the convex portion which is formed by the uneven pattern image and the concave portion which is not formed by the uneven pattern image and an image which is decorated by the concave and convex portions is obtained.

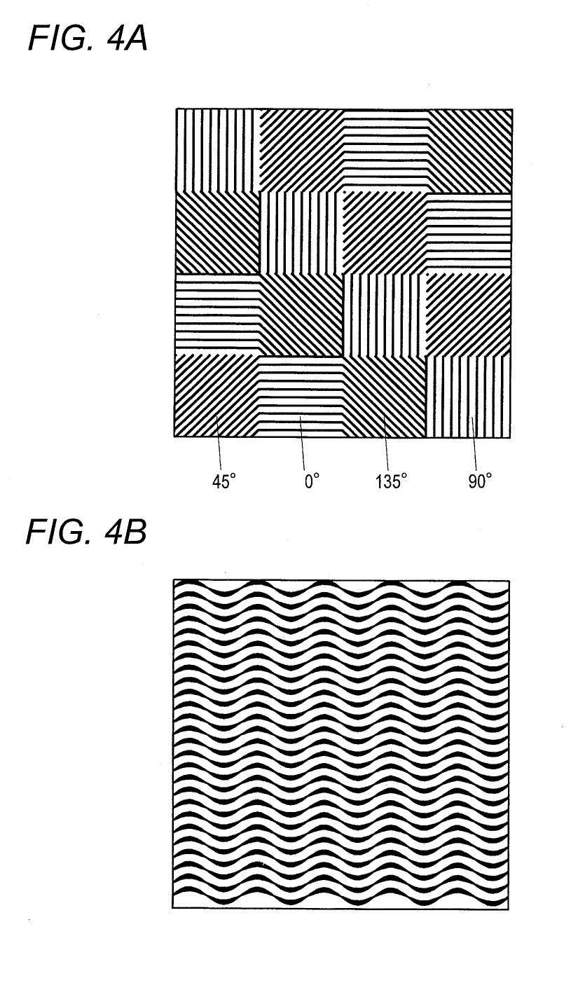

FIGS. 4A and 4B are diagrams illustrating another example of the uneven pattern image. In FIGS. 4A and 4B, a portion which is formed as a convex portion is shown in black. In the uneven pattern image shown in (B) of FIG. 3, stripes are arranged in one direction. When the direction of the stripes is changed, the reflection of light or a shadow due to the concave and convex portions is changed and the perception of the observer obtained from the decoration of the concave and convex portions is changed. In FIG. 4A, the directions of the stripes are 45°, 0°, 135°, and 90° and impression varies depending on the direction of the stripes. In this example, the stripes arranged in different directions are combined with each other. The impression given to the observer varies depending on a combination of the directions of the stripes. The direction of the stripes is not limited to the example shown in FIG. 4A, but the stripes may be arranged in various directions. In addition, the combinations of the directions of the stripes are not limited to the above-mentioned example.

FIG. 4B shows an example in which stripes do not have a straight shape, but have a curve shape. For example, the uneven pattern (the patter having concavity and convexity) has a wave shape. In addition, in FIG. 4B, the widths of the concave and convex portions vary depending on position. Of course, the invention is not limited to the example, but the uneven pattern image may be formed by using various patterns, such as various decorative uneven patterns.

When control is performed during the formation and fixation of the uneven pattern image such that glossy appearance is obtained, the degrees of reflection of light are different in the convex portion and the concave portion and glossiness also varies in the example shown in FIGS. 4A and 4B or other uneven patterns. Therefore, when the uneven pattern is changed, the glossiness of the formed image is also changed.

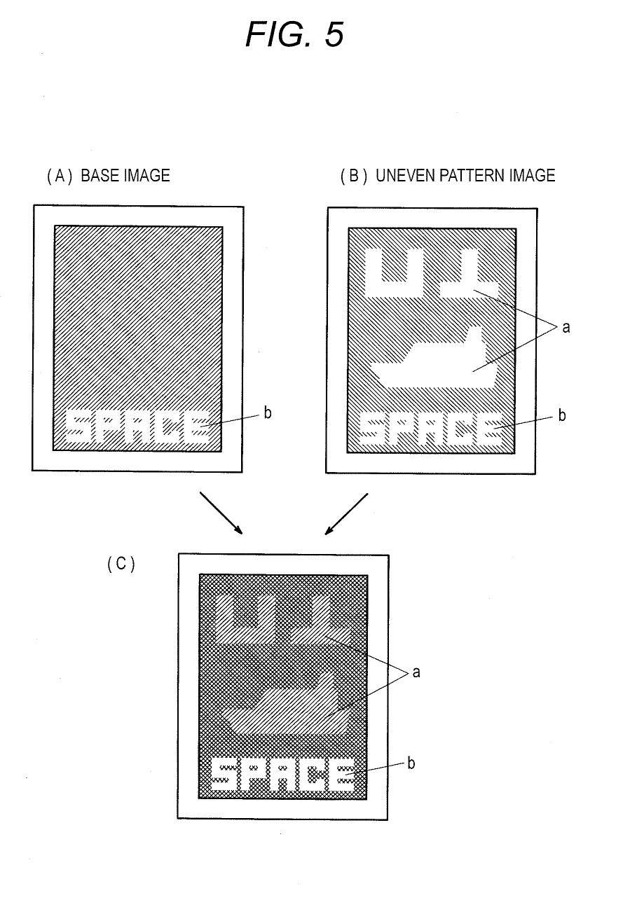

FIG. 5 is a diagram illustrating another example of the base image and the uneven pattern image. (A) of FIG. 5 shows an example of the base image and (B) of FIG. 5 shows an example of the uneven pattern image. For convenience of illustration, in the example of the base image shown in (A) of FIG. 5, a colored portion is represented by oblique lines. In the example of the uneven pattern image shown in (B) of FIG. 5, an uneven pattern is represented by oblique lines different from those in the base image.

In the example shown in FIG. 5, in a figure portion of the uneven pattern image which is superimposed on the colored portion of the base image, a region a is partially removed. When the base image and the uneven pattern image are formed so as to be superimposed on each other and are then fixed, the base image is viewed through a portion of the uneven pattern image from which figures are removed, and the partially removed potion is viewed differently from the uneven portions (concave and convex portions), as shown in (C) of FIG. 5. As such, meaningful information, such as figures or letters, may be represented by the presence or absence of the uneven pattern. In FIG. 5, regions b of the base image and the uneven pattern image are not colored. In this case, other colors of the medium are viewed. For example, figures or letters may be represented by this method.

Of course, the color of each portion of the image may be changed. When a region is decorated by the uneven pattern, the uneven pattern is formed in the same or similar color to that of the corresponding region of the base image. An image in the region which is not decorated by the uneven pattern is not limited to the base image, but may be the uneven pattern image.

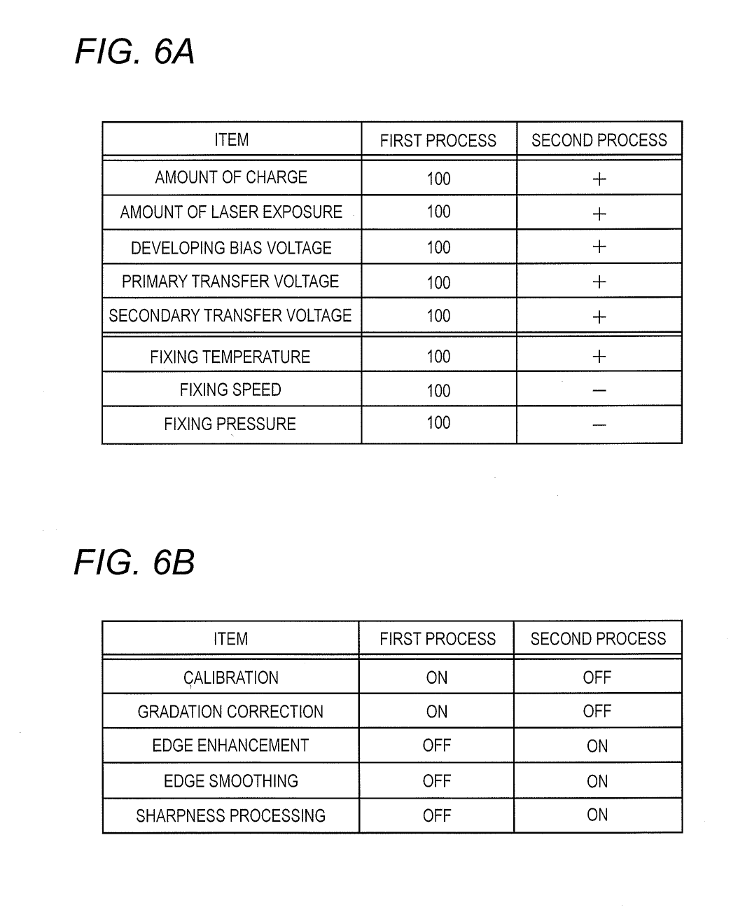

FIGS. 6A and 6B are diagrams illustrating an example of the control of the forming unit and the fixing unit by the control unit. When an image is formed, the control unit 13 sets various settings of the forming unit 11 and the fixing unit 12. An example of the settings is shown in FIG. 6A. In this example, for each setting item, a symbol ‘+’ indicates a case in which a set value in a second process of forming and fixing the uneven pattern image is greater than a set value in a first process of forming and fixing the base image and a symbol ‘−’ indicates a case in which the set value in the second process is less than the set value in the first process. For the items, such as the amount of charging, the amount of exposure, a developing bias voltage, and primary and secondary transfer voltages, which are set to the forming unit 11, the set values in the second process may be greater than those in the first process. According to these settings, in the second process, the amount of color material used is more than that in the first process and the height of the convex portion or the depth of the concave portion increases.

In addition, for the items, such as a fixing temperature, a fixing speed, and fixing pressure, which are set to the fixing unit 12, the fixing temperature in the second process may be set to be more than that in the first process and the second fixing speed and the fixing pressure in the second process may be set to be less than those in the first process. For the setting of the fixing temperature and the fixing speed, the amount of energy applied in the second process is more than that in the first process and glossiness is improved. In addition, the fixing pressure is set so as to minimize the damage of the concave and convex portions formed in the second process.

FIG. 6B shows an example of the items of the processes which are performed for the base image and the uneven pattern image before an image is formed and settings for the processes. In the first process of forming and fixing the base image, calibration and gradation correction items are turned on and edge enhancement, edge smoothing, and sharpness processing items are turned off. For example, since small figures or letters are basically not arranged in the base image, edge enhancement, edge smoothing, and sharpness processing are not needed and are turned off. Even when these items are turned on, the amount of processing does not increase, as compared to when these items are turned on, which causes no problem. In the second process of forming and fixing the uneven pattern image, the calibration and gradation correction items are turned off. When the image is corrected by calibration or gradation correction such that the density thereof is reduced, pixels in the convex portion are likely to be lost in, for example, screen processing. In order to solve the problem, the convex portion is reproduced as the convex portion. In addition, the edge enhancement, edge smoothing, and sharpness processing items are turned on to prevent the damage of the uneven pattern.

The control unit 13 sets these settings to the forming unit 11 and fixing unit 12 and performs control such that the forming unit 11 and fixing unit 12 form and fix the base image and the uneven pattern image. As described with reference to FIG. 3, the concave and convex portions (uneven portion) of the uneven pattern image are formed on the base image and an image decorated by the uneven pattern is obtained. The setting items shown in FIGS. 6A and 6B are an illustrative example and other setting items may be set. In addition, some of the setting items shown in FIGS. 6A and 6B may not be set.

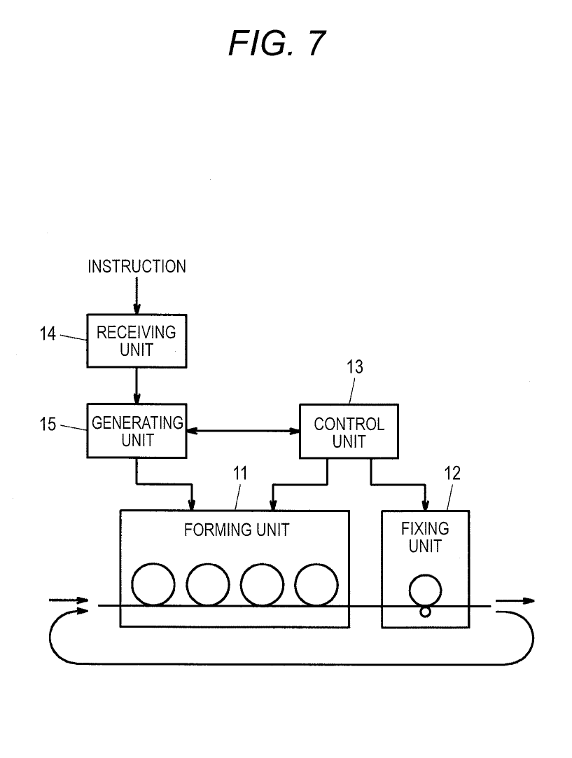

FIG. 7 is a configuration diagram illustrating a modification of the embodiment of the invention. In FIG. 7, reference numeral 14 indicates a receiving unit and reference numeral 15 indicates a generating unit. The base image and the uneven pattern image may be given or they may be generated in response to instructions. In this modification, the base image and the uneven pattern image are generated in response to instructions.

The receiving unit 14 receives an instruction to decorate an image using the uneven pattern and instructions related to various kinds of information required to generate the base image and the uneven pattern image. The receiving unit 14 may receive at least an instruction related to colors and an instruction related to the uneven pattern. For example, when figures or letters are represented by the presence or absence of the uneven pattern as in the example shown in FIG. 5, the receiving unit 14 may receive an instruction to draw the figures or the letters. These various instructions may be performed by, for example, a drawing command, and the receiving unit 14 may receive the drawing command and transmit the drawing command to the generating unit 15.

The generating unit 15 performs a drawing process in response to the instruction received by the receiving unit 14 to generate an image. When the instruction to decorate an image using the uneven pattern is issued, the generating unit 15 generates the base image with instructed colors and generates the uneven pattern image with the instructed colors in response to the instruction related to the uneven pattern. For example, when figures or letters are represented by the presence or absence of the uneven pattern as in the example shown in FIG. 5, the receiving unit 14 may receive an instruction to draw the figures or the letters and the generating unit 15 may generate the base image and the uneven pattern image. The generated base image and uneven pattern image are sequentially transmitted to the forming unit 11 under the control of the control unit 13.

Since the structure and operation of the forming unit 11, the fixing unit 12, and the control unit 13 have been described above, the description thereof will not be repeated. The base image which is generated by the generating unit 15 in the first operation is transmitted to the forming unit 11. The forming unit 11 forms the base image on the medium and the fixing unit 12 fixes the formed image to the medium. The medium returns to the forming unit 11. In the second operation, in S3, the control unit 13 changes the settings of the forming unit 11 and the fixing unit 12. The uneven pattern image generated by the generating unit 15 is transmitted to the forming unit 11. The forming unit 11 forms the uneven pattern image on the medium. The fixing unit 12 fixes the formed image to the medium. As such, two image forming and fixing processes are performed to obtain an image which is decorated by the uneven pattern. The base image and the uneven pattern image may be generated in advance and then two forming and fixing processes may be performed. In addition, after the base image is generated, formed, and fixed, the uneven pattern image may be generated, formed, and fixed.

Specifically, in the example shown in FIG. 5, the receiving unit 14 receives an instruction for colors to be formed, an instruction related to the uneven pattern, an instruction to draw the region a removed from the uneven pattern image, with the base image left, and an instruction to remove both the base image and the uneven pattern image (or to draw the base image and the uneven pattern image). The generating unit 15 generates the base image shown in (A) of FIG. 5 and the uneven pattern image shown in (B) of FIG. 5 on the basis of the information. In the first operation, the base image is transmitted to the forming unit 11, the forming unit 11 forms the base image, and the fixing unit 12 fixes the base image. Then, in the second operation, the uneven pattern image is transmitted to the forming unit 11, the forming unit 11 forms the uneven pattern image, and the fixing unit 12 fixes the uneven pattern image. In this way, the image shown in (C) of FIG. 5 is obtained.

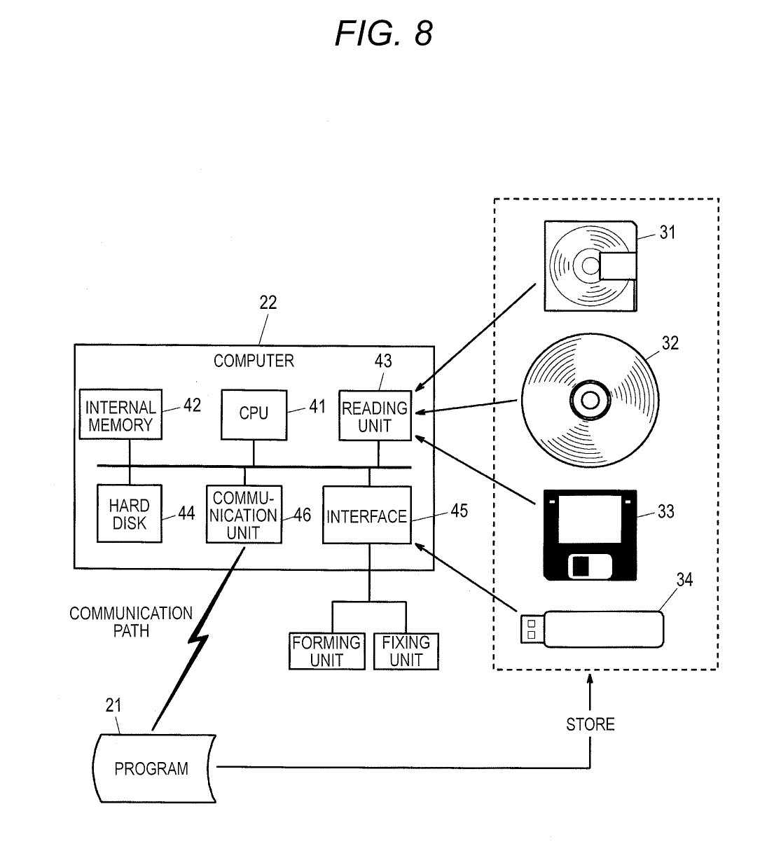

FIG. 8 is a diagram illustrating examples of a computer program, a storage medium storing the computer program, and a computer when the functions described in the embodiment of the image forming apparatus according to the invention and the modification thereof are implemented by the computer program. In FIG. 8, reference numeral 21 indicates a program, reference numeral 22 indicates a computer, reference numeral 31 indicates a magneto-optical disc, reference numeral 32 indicates an optical disc, reference numeral 33 indicates a magnetic disk, reference numeral 34 indicates a memory, reference numeral 41 indicates a CPU, reference numeral 42 indicates an internal memory, reference numeral 43 indicates a reading unit, reference numeral 44 indicates a hard disk, reference numeral 45 indicates an interface, and reference numeral 46 indicates a communication unit.

Some or all of the functions of the control unit 13 described in the embodiment of the image forming apparatus according to the invention and the functions of the receiving unit 14 and the generating unit 15 described in the modification may be implemented by the program 21 executed by the computer. In this case, the program 21 and data used by the program may be stored in the storage medium which is read by the computer. In the storage medium, energy, such as magnetic energy, optical energy, or electric energy, is changed depending on content described in the program and the content described in the program is transmitted in the form of a signal corresponding to the change in energy to the reading unit 43 which is provided in the hardware resources of the computer. Examples of the storage medium include the magneto-optical disc 31, the optical disc 32 (including, for example, a CD and a DVD), the magnetic disk 33, and the memory 34 (including, for example, an IC card, a memory card, and a flash memory). Of course, the storage medium is not limited to a portable type.

The program 21 is stored in the storage medium and the storage medium is inserted into, for example, the reading unit 43 or the interface 45 of the computer 22. The program 21 is read from the computer and is then stored in the internal memory 42 or the hard disk 44 (including, for example, a magnetic disk and a silicon disk). The CPU 41 executes the program 21 to implement some or all of the functions of the control unit 13, the receiving unit 14, and the generating unit 15 described in the embodiment of the image forming apparatus according to the invention and the modification thereof. Alternatively, the program 21 may be transmitted to the computer 22 through a communication path. In the computer 22, the communication unit 46 may receive the program 21, the received program 21 may be stored in the internal memory 42 or the hard disk 44, and the CPU 41 may execute the program 21 to implement the functions.

The forming unit 11 and the fixing unit 12 are connected to the computer 22 through the interface 45 and are controlled by the program 21 to obtain an image. In addition, various devices may be connected through the interface 45. When the computer has the functions of the receiving unit 14, it may receive various instructions through the communication unit 46 or the interface 45. In addition, each component does not operate in one computer, but the processes may be performed in different computers according to the stages of the processes. When the image forming apparatus is applied to other purposes, it may be configured integrally with the program for the purposes. In addition, a portion or the entirety of image forming apparatus may be configured by hardware.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image forming apparatus comprising:
a forming unit that forms an image on a medium;
a fixing unit that fixes the formed image; and
a control unit that performs control such that the forming unit forms a base image and the fixing unit fixes the base image, changes settings of the forming unit and the fixing unit after the fixing of base image, and performs control such that the forming unit forms an uneven pattern image so as to be superimposed on the base image and the fixing unit fixes the uneven pattern image.

2. The image forming apparatus according to claim 1, further comprising:
a receiving unit that receives at least instructions related to a color and a shape; and
a generating unit that generates the base image with instructed color and generates the uneven pattern image having instructed shape with instructed color.

3. An image forming method comprising, in the following order:
forming a base image by a forming unit;
fixing the base image by a fixing unit;
changing settings of the forming unit and the fixing unit;
forming an uneven pattern image by the forming unit so that the uneven pattern image is superimposed on the base image; and
fixing the uneven pattern image by the fixing unit.

4. A computer readable medium storing a program causing a computer to execute a process for image forming, the process comprising, in the following order:
forming a base image by a forming unit;
fixing the base image by a fixing unit;
changing settings of the forming unit and the fixing unit;
forming an uneven pattern image by the forming unit so that the uneven pattern image is superimposed on the base image; and
fixing the uneven pattern image by the fixing unit.

5. The computer readable medium according to claim 4, wherein the process further comprises:
receiving at least instructions related to a color and a shape; and
generating the base image with instructed color and generating the uneven pattern image having instructed shape with instructed color.
